(19) United States
(12) Patent Application Publication
(10) Pub. No.: US 2023/0116358 A1
(43) Pub. Date: Apr. 13, 2023

(54) DIGITIZED SYSTEM AND A METHOD TO DISPLAY, FORMULATE AND MODERATE REPUTATION OR RATING OF A WEBSITE ENTITY

(71) Applicant: Meyyappan Alagappan, Fremont, CA (US)

(72) Inventor: Meyyappan Alagappan, Fremont, CA (US)

(73) Assignee: Meyyappan Alagappan, Fremont, CA (US)

(21) Appl. No.: 17/498,128

(22) Filed: Oct. 11, 2021

(51) Int. Cl. G06Q 30/02

(52) U.S. Cl. CPC G06Q 30/0282

(57) ABSTRACT

A digitized system includes an unbiased entity to display, formulate and moderate reputation of online companies for collecting personal data from online users. The digitized system includes a system for displaying the reputation of online companies in their website to inform or show online users the value the online companies for collecting their personal data. The digitized system includes a system and or a web portal for collecting feedbacks about online companies from online users including user who have provided their personal data and independent agencies. The digitized system includes a system to formulate or calculate the reputation of online companies for collecting personal data based on the feedbacks. Reputation can be a number, a grade, a recommendation, or other types of scoring method. The digitized system includes a system to formulates or calculate the reputation of online companies based on feedbacks kept in a blockchain. The digitized system includes a system and or a web portal for online companies to challenge the feedbacks provided by online users and/or independent agencies

### FIELD OF THE INVENTION

The present invention relates to a system and a method for rating a website entity. More particularly, the present invention relates to system and a method for formulating reputation scoring of a website which collects personal information of a user.

### BACKGROUND OF THE INVENTION

In the today's world people often do share their personal data with many business entities over internet. These personal data of the user can be utilised by the business entities without their consent for their marketing or any other business purposes. Maybe the personal information can be shared with other business entities without the consent of the user. That is why personal identity theft is becoming a serious crime. Personal identity theft is a process of stealing personal information of the user and using it without user consent. The personal information is information that identifies, relates to, or could reasonably be linked with you or your household. For example, it could include name, social security number, email address, records of products purchased, internet browsing history, geolocation data, fingerprints, and inferences from other personal information that could create a profile about your preferences and characteristics.

However, because of the numerous uses of an individual's personal information used to confirm identity, it is not easy to prevent someone from accessing all private information. Although the users can take precautionary measures to prevent their identities from being easily stolen, such as to make sure the website sites are secure. Generally, the URL will have a lock in the left-hand corner and start with “https” may ensure a secure website. But there is no surety that the particular website may not steal the personal information of the user and sell the personal information with other website entities. The user/customer can be easily cheated by these website entities and the effects can be more than just an inconvenience.

Therefore, there is a need of a system and a method for rating a website entity which can overcome the limitations of the existing prior art.

An object of the present invention is to provide digitized system and a method to display, formulate and moderate reputation of a website entity.

Another object of the present invention is to provide digitized system and a method to display, formulate and moderate reputation of a website entity for collecting personal data from online users.

Yet another object of the present invention is to provide a system and a method for users to report any misuse of personal data by the web entity

Yet another object of the present invention is to provide a system and a method for the website entities to challenge the feedbacks provided by online users and/or independent agencies.

One more object of the present invention is to provide a system and a method to capture and store online user consents for collecting personal data by website entities.

Further object of the present invention is to provide a system and a method for displaying terms and conditions for using, storing, and safeguarding the personal data collected by website entities.

Still one more object of the present invention is to provide a system and a method, which facilities the online users to login, view consents, revoke consents and perform other relevant activities to manage consents.

Yet another object of the present invention is to provide a system and a method, which facilitates the website entities to login, setup account, view consents, pull reports for auditing and perform other relevant activities to manage consents.

One more object of the present invention is to provide a system and a method, which masks the online user personal information such as email address, phone number and other information when submitting to website entities and still get in touch with the online user with the masked data without exposing the original data.

One more object of present invention is a system and a method for providing website entities a seamless way to contact the user with the masked data.

### SUMMARY OF THE INVENTION

According to the present invention, there is provided digitized system to display, formulate and moderate reputation of a website entity for collecting personal data from online users. The system may be implemented on any computing device that can support browsing. Such a computing device may include, but is not limited to, a computing device having a processor and memory for executing and storing instructions. Such a device may include software, firmware, and hardware. Software may include one or more applications and an operating system. Hardware can include, but is not limited to, a processor, memory and user interface display. Example of computing devices that can support web browsing include but are not limited to a computer, workstation, mobile device, set-top box, or cluster of computers.

In a first aspect of the invention, the system includes an application module which process in conjunction with a web browser. Specifically, the application module is a web plug-in. The application module facilitates to display, formulate and moderate reputation of a website entity for collecting personal data from online users. Specifically, the application module is capable of displaying the reputation of website entities in their web portal to inform or show online users the value the website entities for collecting their personal data.

In the present embodiment, the application module is capable of displaying the reputation score of the website entity on a website portal hosted by the website entity. The reputation score of the website entity reveals the authenticity of the website entity in managing the personal data of the user. The reputation score can be a number, a grade, a recommendation, or other types of scoring method. If the reputation score is less, then the website entity is not trustworthy or is incapable of managing the personal data of the users securely. The reputation score of the website entity is based on feedback from the user. The application module includes a web portal for collecting feedbacks about the website entities from online users including user who have provided their personal data and independent agencies. Specifically, the application module is capable of formulating or calculating the reputation of the website entity based on feedbacks kept in a blockchain. In the present embodiment, web portal associated with the application module displays the reputation score of the website entity. The application module is a display interface displayed on top of an account application field of the website entity. The web portal for the website entities facilitates in challenging the feedbacks provided by online users and/or independent agencies.

Further, the web portal of the application module is linked with a cloud platform. The cloud platform may have the user ratings of the website entity stored therein. The application module can retrieve the user ratings of the website entity and can display the website rating on a display interface of the web portal. For example, the application module may retrieve the user ratings from the cloud platform and calculates the total user rating accordingly. Then the application module formulates the average of the user rating and displays the formulated user rating on the display interface of the web portal.

In an embodiment, the application module is capable of collecting feedbacks about the website entity from the online users including user who have provided their personal data and independent agencies. Further, if the personal data security is violated by the website entity, the user can utilise the web portal associated with the application module to raise an enquiry so that user can question the website entity for violating the rights of the online user.

In another aspect of the invention, a digitized system to capture and store online user consents for collecting personal data by website entities is provided. The digitized system includes an application module which can capture and store online user consents for collecting personal data by the website entities. The application module is capable of displaying terms and conditions for using, storing, and safeguarding the personal data collected by website entities. Specifically, the application module includes a backend system that captures the online user consent for collecting personal data by the website entity. This consent is preserved in the backend along with time of when the consent was given, email address of the online user, IP address of the online user and/or other details relevant to the consent. When the user consent is registered with the system the website entity can contact the online users.

Further, the system includes a web portal associated with the application module. In an embodiment, the online user can utilise the web portal of the application module to manage the consents. Specifically, the user can login, view consents, revoke consents and perform other relevant activities to manage consents through the web portal. If the consent is not registered with the system, the website entity cannot extract the personal information from the cloud platform linked with the application module. Further, if the website entity violates the user rights, the user can revoke the consents and can thereby block further communication of the website entities with the online users.

In another aspect of the invention, the system includes a web portal associated with the application module which can be utilised by the website entity. The website entity can utilise the web portal for viewing consents of the online users, pull reports for auditing and perform other relevant activities to manage consents.

In another aspect of the invention, a digitised system to mask user personal data when submitting to the website portal of the website entity is provided. The system includes an application module to mask online user personal data when submitting to the website entity and still get in touch with the online user with the masked data without exposing the original data. The application module includes a web portal which is linked to the cloud platform for storing the user data. The web portal can be utilised by the online user to login and setup an account with original personal data such emails address, phone number etc.

The personal information input through the web portal is stored in the database of the cloud platform. In the present embodiment, the personal data is masked by the application module before storing in the cloud database. Specifically, the application module hides the actual entered personal data using modified content like characters or numbers to create an alternate version of the data that cannot be easily identifiable, or reverse engineered. Masking the personal data increases the security so that the website entity cannot reach to the actual entered personal data.

If the personal information exists within the cloud database, then the application module auto fills with the available masked data. The system includes a plugin that reside on the website of the website entities, which provides online users to auto fill with their masked data through the plugin. If the personal information is not available in the cloud database, the user is prompted to make an account through the web interface associated with the application module.

Further, the website entity can still get in touch with the online user with the masked data without exposing the original data. For example, the website can make phone calls with the masked phone number or exchange emails with masked email address with the online users. In an aspect of the invention, the online users can block further communication of website entities with the online users.

In another aspect of the invention, the system includes a first application module, a second application module and a third application module. The first application module is to display, formulate and moderate reputation of a website entity for collecting personal data from online users. The second application module is to capture and store online user consents for collecting personal data by website entities. The third application module to mask online user personal data when submitting to website entities and still get in touch with the online user with the masked data without exposing the original data.

In another aspect of the invention a method for formulating reputation score of a website entity is provided. The method is implemented on any computing device which support web browsing. Initially, a personal data of a user is provided in a website portal hosted by a website entity. The personal data is accessed by a first application module associated with the computing device and stores the personal data in a cloud database through a web portal associated with the first application module. The personal data is masked by a third application module before storing in the cloud database.

Further, capturing and storing online user consents for collecting personal data by the website entities by the second application module. The second application module includes a backend system that captures the online user consent for collecting personal data by the website entity. This consent is preserved in the backend along with time of when the consent was given, email address of the online user, IP address of the online user and/or other details relevant to the consent. When the user consent is registered with the system the website entity can contact the online users.

In the next step, utilising the web portal associated with the first application module to raise an enquiry if the personal data security is violated by the website entity. The user can question the website entity for violating the rights of the online user. Further, if the website entity violates the user rights, the user can revoke the consents and can thereby block further communication of the website entities with the online users.

Further, providing and or displaying the reputation score of the website entity based on the feedbacks collected from the user about the website entity. Specifically, the web portal of the first application module can display a feedback interface through which the user can give reputation score of the website entity.

### BRIEF DESCRIPTION OF THE DRAWINGS

The advantages and features of the present invention will be understood better with reference to the following detailed description and claims taken in conjunction with the accompanying drawings, wherein like elements are identified with like symbols, and in which:

FIG. 1 illustrates a schematic representation of a digitized system to display, formulate and moderate reputation of a website entity in accordance with the present invention;

FIG. 2 illustrates an embodiment of a digitized system to display, formulate and moderate reputation of a website entity for collecting personal data from online users;

FIG. 2a is an example illustrating the embodiment described in FIG. 2;

FIG. 3 illustrates an embodiment of a digitized system to capture and store online user consents for collecting personal data by website entities is provided;

FIG. 3a is an example illustrating the embodiment described in FIG. 3;

FIG. 4 illustrates an embodiment of a digitized system to mask online user personal data when submitting to website entities is illustrated;

FIG. 4a is an example illustrating the embodiment described in FIG. 4; and

FIG. 5 illustrates a flow chart representing a method for formulating reputation score of a website entity in accordance with the present invention.

### DETAILED DESCRIPTION OF THE INVENTION

An embodiment of this invention, illustrating its features, will now be described in detail. The words “comprising, “having, “containing,” and “including,” and other forms thereof, are intended to be equivalent in meaning and be open-ended in that an item or items following any one of these words is not meant to be an exhaustive listing of such item or items, or meant to be limited to only the listed item or items.

The terms “first,” “second,” and the like, herein do not denote any order, quantity, or importance, but rather are used to distinguish one element from another, and the terms “an” and “a” herein do not denote a limitation of quantity, but rather denote the presence of at least one of the referenced item.

The disclosed embodiments are merely exemplary of the invention, which may be embodied in various forms.

The present invention describes a digitized system to display, formulate and moderate reputation of a website entity for collecting personal data from online users. Many a times, people used to share their personal information with a website by fielding an account application on the website. The account application may ask for the personal data such as name, social security number, email address, records of products purchased, internet browsing history, geolocation data, fingerprints and the like. These personal data is stored within a database linked with the website. For many reasons, the website entity or the business entity may sell this personal information stored in their database. The security of these personal data is a question in front of the users. Hence, the present invention is provided to overcome the identity theft by the website entities.

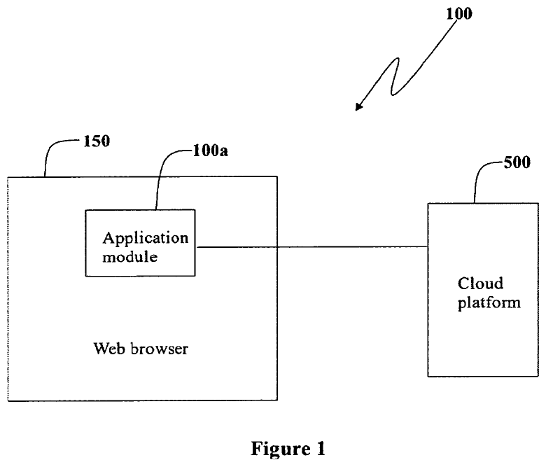

Referring now to FIG. 1, a schematic representation of a digitized system (herein after referred as system 100) to display, formulate and moderate reputation of a website entity for collecting personal data from online users in accordance with the present invention is illustrated. The system (100) may be implemented on any computing device (150) that can support browsing. Such a computing device (150) may include, but is not limited to, a computing device (150) having a processor and memory for executing and storing instructions. Such a device may include software, firmware, and hardware. Software may include one or more applications and an operating system. Hardware can include, but is not limited to, a processor, memory and user interface display. Example of computing devices (150) that can support web browsing include but are not limited to a computer, workstation, mobile device, set-top box, or cluster of computers.

In a first aspect of the invention, referring to FIG. 1, the system (100) includes an application module (100a) which process in conjunction with a web browser. Specifically, the application module (100a) is a web plug-in. The system (100) may include a webpage rendering module that renders a portion of the web content while using the web browser and includes an interface adapted to access the application module (100a). The application module (100a) facilitates to display, formulate and moderate reputation of a website entity for collecting personal data from online users. Specifically, the application module (100a) is capable of displaying the reputation of website entities in their web portal to inform or show online users the value the website entities for collecting their personal data.

In the present embodiment, the application module (100a) is capable of displaying the reputation score of the website entity on a website portal hosted by the website entity. The reputation score of the website entity reveals the authenticity of the website entity in managing the personal data of the user. The reputation score can be a number, a grade, a recommendation, or other types of scoring method. If the reputation score is less, then the website entity is not trustworthy or is incapable of managing the personal data of the users securely. The reputation score of the website entity is based on feedback from the user. The application module (100a) includes a web portal for collecting feedbacks about the website entities from online users including user who have provided their personal data and independent agencies. Specifically, the application module (100a) is capable of formulating or calculating the reputation of the website entity based on feedbacks kept in a blockchain. In the present embodiment, web portal associated with the application module (100a) displays the reputation score of the website entity. The application module (100a) is a display interface displayed on top of an account application field of the website entity. It may be obvious to a person skilled in the art to setup the configuration displaying the application module (100a) anywhere on the website portal of the website entity. The web portal for the website entities facilitates in challenging the feedbacks provided by online users and/or independent agencies.

Further, the web portal of the application module (100a) is linked with a cloud platform/database (500). The cloud platform (500) may have the user ratings of the website entity stored therein. The application module (100a) can retrieve the user ratings of the website entity and can display the website rating on a display interface of the web portal. For example, the application module (100a) retrieves the user ratings from the cloud platform (500) and calculates the total user rating accordingly. Then the application module (100a) formulates the average of the user rating and displays the formulated user rating on the display interface of the web portal.

In an embodiment, the application module (100a) is capable of collecting feedbacks about the website entity from the online users including user who have provided their personal data and independent agencies. Specifically, the web portal of the application module (100a) can display a feedback interface through which the user can give reputation score of the website entity. By way of non-limiting example, the feedback interface may be star rating interface thorough which the user can provide a star rating for the website entity in managing the personal data of the user securely. If the website entity is not managing the personal data of the user, the user may reduce the star rating of the website entity. It may be obvious to a person skilled in the art to configure any other reputation scoring system other than the star rating.

Further, if the personal data security is violated by the website entity, the user can utilise the web portal associated with the application module (100a) to raise an enquiry so that user can question the website entity for violating the rights of the online user. The web portal also showcases the time period by which the application module (100a) started collecting the information about the website entity. Also, the web portal showcases the open issues/enquiries raised by the user about the website entity.

In another aspect of the invention, a system (100) to capture and store online user consents for collecting personal data by website entities is provided. The system includes an application module (100a) which can capture and store online user consents for collecting personal data by the website entities. The application module (100a) is capable of displaying terms and conditions for using, storing, and safeguarding the personal data collected by website entities. Specifically, the application module (100a) includes a backend system that captures the online user consent for collecting personal data by the website entity. This consent is preserved in the backend along with time of when the consent was given, email address of the online user, IP address of the online user and/or other details relevant to the consent. When the user consent is registered with the system (100), the website entity can contact the online users. Specifically, when the consent is registered with the system (100), the user authorises the website entity to collect the personal information of the user.

Further, the system includes a web portal associated with the application module (100a). In an embodiment, the online user can utilise the web portal of the application module (100a) to manage the consents. Specifically, the user can login, view consents, revoke consents and perform other relevant activities to manage consents through the web portal. If the consent is not registered with the system (100), the website entity cannot extract the personal information from the cloud platform (500) linked with the application module (100a). Further, if the website entity violates the user rights, the user can revoke the consents and can thereby block further communication of the website entities with the online users.

In another aspect of the invention, the system includes a web portal associated with the application module (100a) which can be utilised by the website entity. The website entity can utilise the web portal for viewing consents of the online users, pull reports for auditing and perform other relevant activities to manage consents. By way of non-limiting example, the website entity can setup an account in the system (100) and utilise the web portal associated with the application module (100a) to retrieve data related to the consents from the users. The application module (100a) is useful for both the online users and the website entity.

In another aspect of the invention, a digitised system (100) to mask user personal data when submitting to the website portal of the website entity is provided. The system (100) includes an application module (100a) to mask online user personal data when submitting to the website entity and still get in touch with the online user with the masked data without exposing the original data. The application module (100a) includes a web portal which is linked to the cloud platform (500) for storing the user data. The web portal can be utilised by the online user to login and setup an account with original personal data such emails address, phone number etc.

The personal information input through the web portal is stored in the database of the cloud platform (500). In the present embodiment, the personal data is masked by the application module (100a) before storing in the cloud platform (500). Specifically, the application module (100a) hides the actual entered personal data using modified content like characters or numbers to create an alternate version of the data that cannot be easily identifiable, or reverse engineered. Masking the personal data increases the security so that the website entity cannot reach to the actual entered personal data.

For example, when an online user is registering or fielding an account application of the website entity, the entered data is fetched by the application module (100a) and is checked within the database of the cloud platform/database (500) linked with the application module (100a).

If the personal information exists within the cloud platform (500), then the application module (100a) auto fills with the available masked data. The system includes a plugin that reside on the website of the website entities, which provides online users to auto fill with their masked data through the plugin. If the personal information is not available in the cloud platform (500), the user is prompted to make an account through the web interface associated with the application module (100a).

Further, the website entity can still get in touch with the online user with the masked data without exposing the original data. For example, the website can make phone calls with the masked phone number or exchange emails with masked email address with the online users. In an aspect of the invention, the online users can block further communication of website entities with the online users.

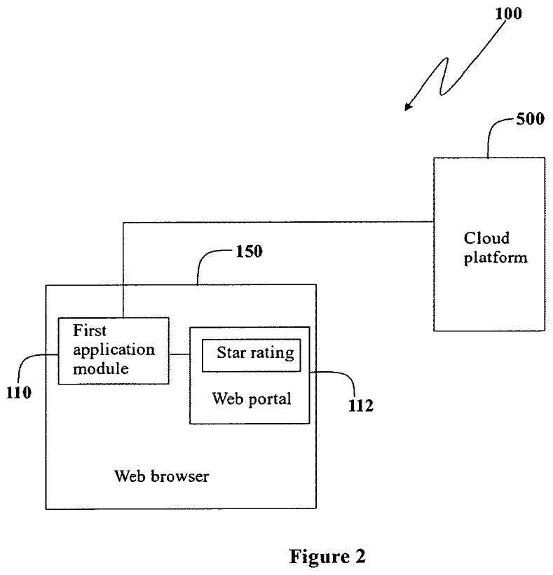

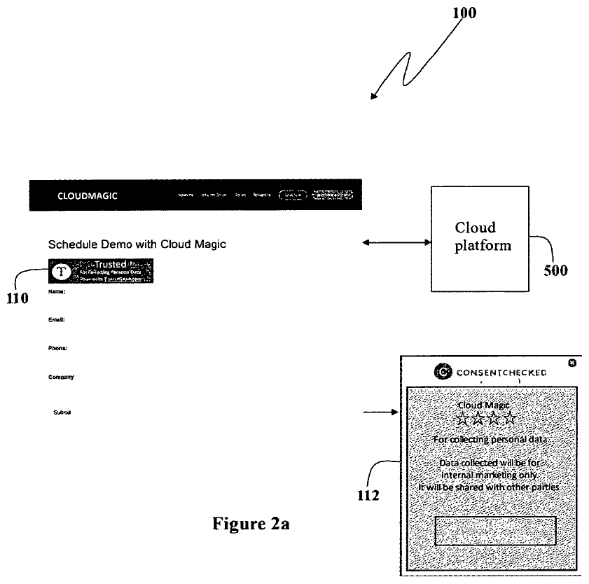

In another aspect of the invention as shown in FIGS. 2, 3, and 4, the system (100) includes a first application module (110), a second application module (120) and a third application module (130). The first application module (110) is to display, formulate and moderate reputation of a website entity for collecting personal data from online users. The second application module (120) is to capture and store online user consents for collecting personal data by website entities. The third application module (130) to mask online user personal data when submitting to website entities and still get in touch with the online user with the masked data without exposing the original data.

In the present embodiment, the first application module (110) is capable of displaying the reputation of website entities in their website portal to inform or show online users the value the website entities for collecting their personal data.

Referring now to FIG. 2a, the first application module (110) is capable of displaying the reputation score of the website entity on a website portal hosted by the website entity. The reputation score of the website entity reveals the authenticity of the website entity in managing the personal data of the user. The reputation score can be a number, a grade, a recommendation, or other types of scoring method. If the reputation score is less, then the website entity is not trustworthy or is incapable of managing the personal data of the users securely. The reputation score of the website entity is based on feedback from the user. The first application module (110) includes a web portal (112) for collecting feedbacks about the website entities from online users including user who have provided their personal data and independent agencies. Specifically, the first application module (110) is capable of formulating or calculating the reputation of the website entity based on feedbacks kept in a blockchain. In the present embodiment, web portal (112) associated with the application module (120) displays the reputation score of the website entity. The first application module (110) is a display interface displayed on top of an account application field of the website entity. It may be obvious to a person skilled in the art to setup the configuration displaying the first application module (110) anywhere on the website portal of the website entity. The web portal (112) for the website entities facilitates in challenging the feedbacks provided by online users and/or independent agencies.

Further, the web portal (112) of the first application module (110) is linked with a cloud platform (500) containing a cloud database. The cloud platform (500) may have the user ratings of the website entity stored therein. The web portal (112) of the application module can retrieve the user ratings of the website entity and can display the website rating on a display interface of the web portal (112). For example, the first application module (110) retrieves the user ratings from the cloud platform (500) and calculates the total user rating accordingly. Then the first application module (110) formulates the average of the user rating and displays the formulated user rating on the display interface of the web portal (112).

In an embodiment, the first application module (110) is capable of collecting feedbacks about the website entity from the online users including user who have provided their personal data and independent agencies. Specifically, the web portal (112) of the first application module (110) can display a feedback interface through which the user can give reputation score of the website entity. By way of non-limiting example, the feedback interface may be star rating interface thorough which the user can provide a star rating for the website entity in managing the personal data of the user securely. If the website entity is not managing the personal data of the user, the user may reduce the star rating of the website entity. Referring to FIG. 2a, an example illustrating the display of reputation score in a website portal of the website entity is shown. It may be obvious to a person skilled in the art to configure any other reputation scoring system other than the star rating.

Further, if the personal data security is violated by the website entity, the user can utilise the web portal (112) associated with the first application module (110) to raise an enquiry so that user can question the website entity for violating the rights of the online user. The web portal (112) also showcases the time period by which the first application module (110) started collecting the information about the website entity. Also, the web portal (112) showcases the open issues/enquiries raised by the user about the website entity.

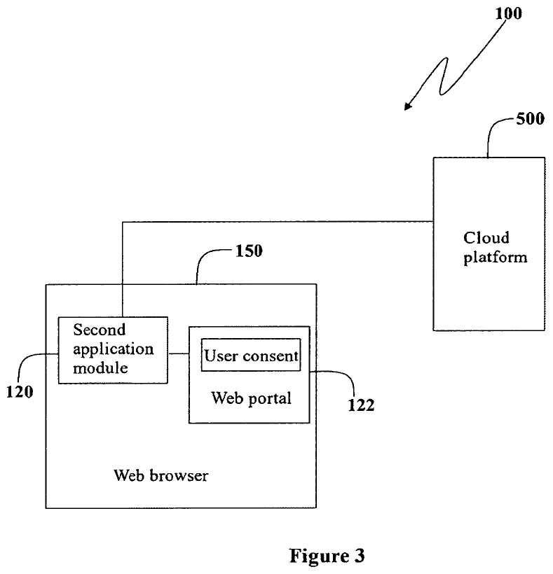

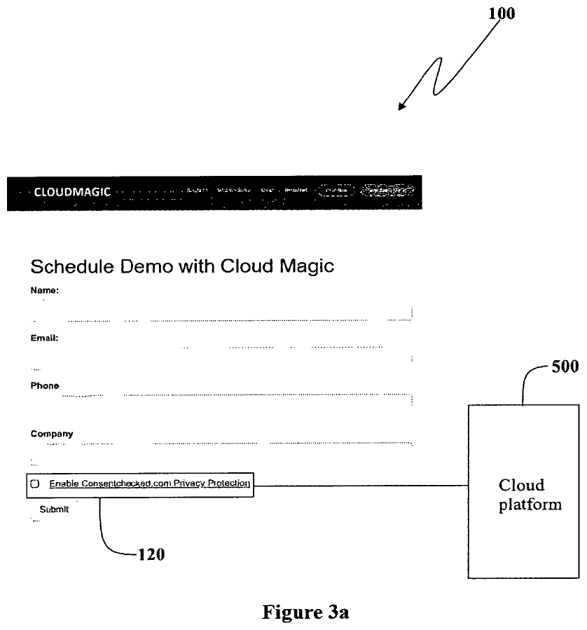

Further referring to FIG. 3, the digitized system includes the second application module (120) which can capture and store online user consents for collecting personal data by the website entities. Referring now to FIG. 3a, the second application module (120) is capable of displaying terms and conditions for using, storing, and safeguarding the personal data collected by website entities. Specifically, the second application module (120) includes a backend system that captures the online user consent for collecting personal data by the website entity. This consent is preserved in the backend along with time of when the consent was given, email address of the online user, IP address of the online user and/or other details relevant to the consent. When the user consent is registered with the system (100), the website entity can contact the online users. Specifically, when the consent is registered with the system (100), the user authorises the website entity to collect the personal information of the user.

Further, the system includes a web portal (122) associated with the second application module (120). In an embodiment, the online user can utilise the web portal (122) of the second application module (120) to manage the consents as shown in FIG. 3a. Specifically, the user can login, view consents, revoke consents and perform other relevant activities to manage consents through the web portal (122). If the consent is not registered with the system (100), the website entity cannot extract the personal information from the cloud platform (500) linked with the second application module (120). Further, if the website entity violates the user rights, the user can revoke the consents and can thereby block further communication of the website entities with the online users.

In another aspect of the invention, the system includes a web portal (122) associated with the second application module (120) which can be utilised by the website entity. The website entity can utilise the web portal (122) for viewing consents of the online users, pull reports for auditing and perform other relevant activities to manage consents. By way of non-limiting example, the website entity can setup an account in the system (100) and utilise the web portal (122) associated with the second application module (120) to retrieve data related to the consents from the users. The second application module (120) is useful for both the online users and the website entity.

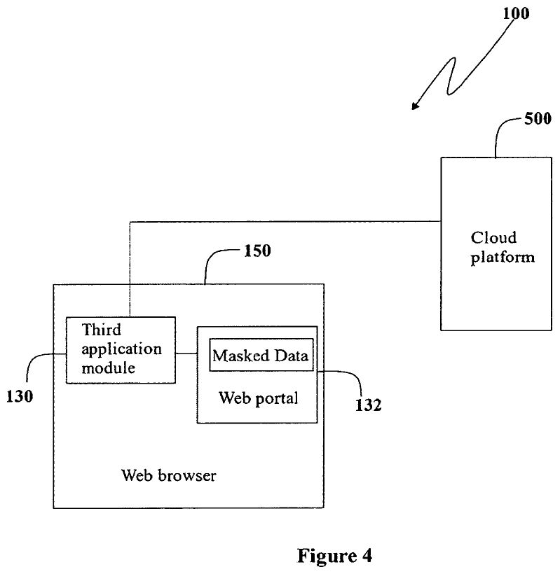

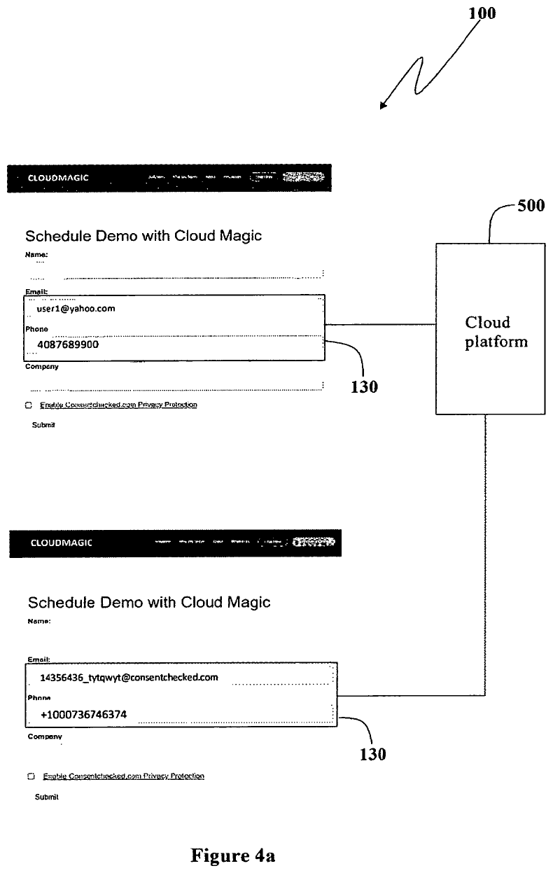

Further referring to FIG. 4, the digitised system includes the third application module (130) to mask online user personal data when submitting to the website entity and still get in touch with the online user with the masked data without exposing the original data. The third application module (130) includes a web portal (132) which is linked to the cloud platform (500) for storing the user data. The web portal (132) can be utilised by the online user to login and setup an account with original personal data such emails address, phone number etc.

The personal information input through the web portal (132) is stored in the database of the cloud platform (500). In the present embodiment as shown in FIG. 4a, the personal data is masked by the third application module (130) before storing in the database of the cloud platform (500). Specifically, the third application module (130) hides the actual entered personal data using modified content like characters or numbers to create an alternate version of the data that cannot be easily identifiable, or reverse engineered. Masking the personal data increases the security so that the website entity cannot reach to the actual entered personal data.

For example, as shown in FIG. 4a, when an online user is registering or fielding an account application of the website entity, the entered data is fetched by the third application module (130) and is checked within the database of the cloud platform (500) linked with the third application module (130).

If the personal information exists within the database of the cloud platform (500), then the third application module (130) auto fills with the available masked data. The system includes a plugin that reside on the website of the website entities, which provides online users to auto fill with their masked data through the plugin. If the personal information is not available in the database of the cloud platform (500), the user is prompted to make an account through the web interface associated with the third application module (130).

Further, the website entity can still get in touch with the online user with the masked data without exposing the original data. For example, the website can make phone calls with the masked phone number or exchange emails with masked email address with the online users. In an aspect of the invention, the online users can block further communication of website entities with the online users.

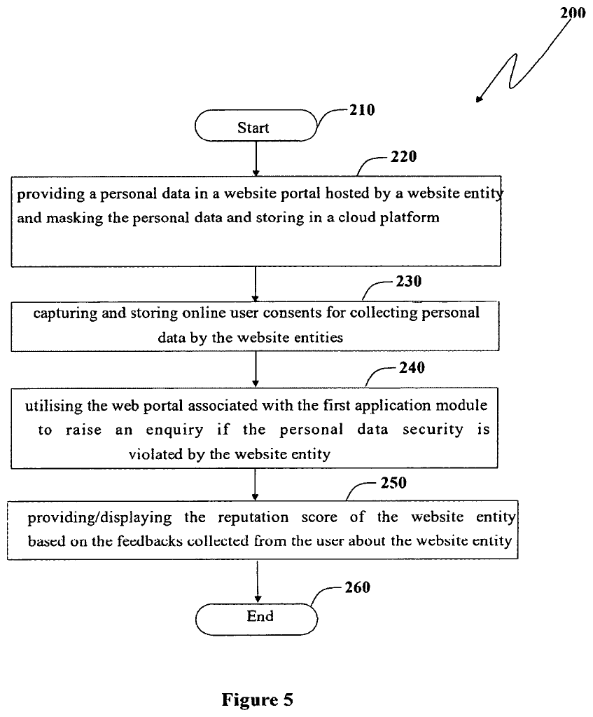

Referring now to FIG. 5, another aspect of the invention is disclosed. Referring to FIG. 5, a method (200) to display, formulate and moderate reputation of a website entity in accordance with the present invention is illustrated. The method (200) is implemented on any computing device (150) which support web browsing. For the sake of brevity, the method is described in conjunction with the system (100).

The method (200) starts at step 210.

At step 220, a personal data of a user is provided in a website portal hosted by a website entity. The personal data is accessed by a first application module (110) associated with the computing device and stores the personal data in a database of the cloud platform (500) through a web portal (112) associated with the first application module (110). The personal data is masked by a third application module (130) before storing in the cloud database. The personal data can be a name, social security number, or email address of the user. If the personal information exists within the cloud database, then a plugin associated with the computing device auto fills with the available masked data. If the personal information is not available in the cloud database, the user is prompted to make an account through the web portal (112) associated with the first application module (110).

At step 230, capturing and storing online user consents for collecting personal data by the website entities by the second application module (120). The second application module (120) includes a backend system that captures the online user consent for collecting personal data by the website entity. This consent is preserved in the backend along with time of when the consent was given, email address of the online user, IP address of the online user and/or other details relevant to the consent. When the user consent is registered with the system (100), the website entity can contact the online users. Specifically, when the consent is registered with the system (100), the user authorises the website entity to collect the personal information of the user. In an embodiment, the user can utilise the web portal (122) of the second application module (120) to manage the consents. For example, the user can view consents, revoke consents and perform other relevant activities to manage consents. If the consent is not registered with the system (100), the website entity cannot extract the personal information from the database of the cloud platform (500) linked with the second application module (120).

At step 240, utilising the web portal (112) associated with the first application module (110) to raise an enquiry if the personal data security is violated by the website entity. The user can question the website entity for violating the rights of the online user. Further, if the website entity violates the user rights, the user can revoke the consents and can thereby block further communication of the website entities with the online users.

At step 250, providing and or displaying the reputation score of the website entity based on the feedbacks collected from the user about the website entity. Specifically, the web portal (112) of the first application module (110) can display a feedback interface through which the user can give reputation score of the website entity.

The web portal (112) of the first application module (110) is linked with a cloud platform (500). The cloud platform (500) may have the user ratings of the website entity stored therein. The first application module (110) can retrieve the user ratings of the website entity and can display the website rating on a display interface of the web portal (112). For example, the first application module (110) retrieves the user ratings from the cloud platform (500) and calculates the total user rating accordingly. Then the first application module (110) formulates the average of the user rating and displays the formulated user rating on the display interface of the web portal (112).

In an embodiment, the first application module (110) is capable of collecting feedbacks about the website entity from the online users including user who have provided their personal data and independent agencies. Specifically, the web portal (112) of the first application module (110) can display a feedback interface through which the user can give reputation score of the website entity. By way of non-limiting example, the feedback interface may be star rating interface thorough which the user can provide a star rating for the website entity in managing the personal data of the user securely. If the website entity is not managing the personal data of the user, the user may reduce the star rating of the website entity.

The method (200) ends at step 260.

Therefore, the present invention has an advantage of providing a system (100) and a method (200) to display, formulate and moderate reputation of a website entity. The system (100) provides a platform for the website entities to challenge the feedbacks provided by online users and/or independent agencies. The system (100) helps to capture and store online user consents for collecting personal data by website entities. Further the invention provides a system (100) and a method (200) for displaying terms and conditions for using, storing, and safeguarding the personal data collected by website entities. The system (100) and method (200) facilities the online users to login, view consents, revoke consents and perform other relevant activities to manage consents. Further, the system (100) and method (200) facilitate the website entities to login, setup account, view consents, pull reports for auditing and perform other relevant activities to manage consents. Also, the system (100) and method (200) mask the online user personal information when submitting to website entities and still get in touch with the online user with the masked data without exposing the original data.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

I claim:

1. A digitized system comprising an unbiased entity to display, formulate and moderate reputation of online companies for collecting personal data from online users.

2. The digitized system of claim 1, further comprising a system for displaying the reputation of online companies in their website to inform or show online users the value the online companies for collecting their personal data.

3. The digitized system of claim 1, further comprising a system and or a web portal for collecting feedbacks about online companies from online users including user who have provided their personal data and independent agencies.

4. The digitized system of claim 1, further comprising system to formulate or calculate the reputation of online companies for collecting personal data based on the feedbacks. Reputation can be a number, a grade, a recommendation, or other types of scoring method.

5. The digitized system of claim 1, further comprising system to formulates or calculate the reputation of online companies based on feedbacks kept in a blockchain.

6. The digitized system of claim 1, further comprising a system and or a web portal for online companies to challenge the feedbacks provided by online users and/or independent agencies.

7. A digitized system comprising an unbiased entity to capture and store online user consents for collecting personal data by online companies.

8. The digitized system of claim 7, further comprising a system for displaying terms and conditions for using, storing, and safeguarding the personal data collected by online companies.

9. The digitized system of claim 8, further comprising a backend system that captures the online user consent for collecting personal data by online companies. This consent is preserved in the backend along with time of when the consent was given, email address of the online user, IP address of the online user and/or other details relevant to the consent.

10. The digitized system of claim 9, further comprising a web portal for online users to login, view consents, revoke consents and perform other relevant activities to manage consents.

11. The digitized system of claim 10, further comprising a web portal for online companies to login, setup account, view consents, pull reports for auditing and perform other relevant activities to manage consents.

12. A digitized system comprising a system to mask online user personal data when submitting to online companies and still get in touch with the online user with the masked data without exposing the original data.

13. The digitized system of claim 12, further comprising a web portal for online user to login and setup an account with original personal data such emails address, phone number etc.

14. The digitized system of claim 13, further comprising a system or a plugin that reside on the website of online companies, which provides online users to auto fill with their masked data through the plugin.

15. The digitized system of claim 14, further comprising a system where online companies can make phone calls with the masked phone number or exchange emails with masked email address with the online users.

16. The digitized system of claim 15, further comprising a system where online users can block further communication of online companies with the online users using the masked email or masked phone number.

17. A digitized system comprising;
a first application module to display, formulate and moderate reputation of a website entity for collecting personal data from online users;
a second application module to capture and store online user consents for collecting personal data by website entities; and
a third application module to mask online user personal data when submitting to website entities and still get in touch with the online user with the masked data without exposing the original data.

18. A digitized system of claim 17, further comprising a web portal for online companies and online user to register, login and manage or administer all necessary activities to operate or use the system.
